(19) United States
(12) Patent Application Publication
(10) Pub. No.: US 2017/0305003 A1
(43) Pub. Date: Oct. 26, 2017

(54) EXTRACTION DEVICE FOR EXTRACTING A TRIM WEIGHT FROM A ROTOR BLADE

(71) Applicant: AIRBUS HELICOPTERS DEUTSCHLAND GMBH, Donauworth (DE)

(72) Inventor: Alois TANNHAEUSER, Kaisheim (DE)

(73) Assignee: AIRBUS HELICOPTERS DEUTSCHLAND GMBH, Donauworth (DE)

(21) Appl. No.: 15/496,343

(22) Filed: Apr. 25, 2017

(30) Foreign Application Priority Data
Apr. 25, 2016 (EP) 16400013.5

(51) Int. Cl. B25B 27/02; B64C 27/00; B64C 27/473; B64F 5/40

(52) U.S. Cl. CPC B25B 27/02; B64C 27/473; B64F 5/40; B64C 27/001; B64C 2027/005

(57) ABSTRACT

An extraction device for extracting a trim weight from a rotor blade, comprising a supporting tube that is at least partly provided with a female thread, and a threaded rod that is at least partially arranged in the supporting tube, wherein the threaded rod is coupled to a fixing element that is adapted for being detachably fixed to the trim weight and that is at least partially provided with a male thread which engages at least partially the female thread of the supporting tube, and wherein the threaded rod is at least partly plastically deformable.

### CROSS-REFERENCE TO RELATED APPLICATIONS

This application claims priority to European patent application No. EP 16400013.5 filed on Apr. 25, 2016, the disclosure of which is incorporated in its entirety by reference herein.

### BACKGROUND OF THE INVENTION

### (1) Field of the Invention

The invention relates to an extraction device for extracting a trim weight from a rotor blade. Moreover, the invention relates to a method for extracting a trim weight from a rotor blade using such an extraction device.

### (2) Description of Related Art

Rotor blades of rotary wing aircrafts and, in particular, rotor blades of helicopters are usually provided with trim weights or masses to adjust the dynamic behavior of the rotor blades during operation and to avoid undesirable and hazardous vibrations. Due to the relatively high centrifugal forces acting upon the rotor blades during operation, as well as due to corrosion and underlying production conditions, such trim weights are usually clamped in the rotor blades, resp. arranged therein in corresponding trim weight boxes or housings.

However, the trim weights in the trim weight boxes or housings, resp. in the associated rotor blades, are in general relatively difficult to access. In particular, this is due to the fact that usually only a comparatively small access opening enabling a corresponding access is provided at a top of the associated rotor blades.

In general, a required extracting of trim weights from rotor blades is effected manually using customary hand tools, since a tool dedicated to such an extracting has not yet been available so that such a required removing resp. extracting is generally time-consuming and, thus, cost-intensive. From the prior art, merely devices for extracting bearings resp. bearing bushes out of bore holes, in particular blind holes, are known. However, these devices are not suitable for extracting trim weights from rotor blades, as described hereinafter.

For example, the document CN 2 180 416 U describes an extraction device for extracting a rolling bearing from a blind hole, wherein the extraction device comprises a pulling sleeve and a screw jack. The pulling sleeve has an elastic, expandable clamping head provided with an outer, symmetric annular shoulder. Inside this clamping head, there is a symmetric, conical surface and in the inner center part, a symmetric, concave, circular arc is provided. In the area of the symmetric, conical surface, there is a steel ball which can be subjected to the action of a transmission rod in the direction of the symmetric, conical surface. On the opposing end of the transmission rod, a screw with male thread is screwed into the clamping head. The screw jack comprises a tie rod and an annular hammer, wherein the front end of the tie rod is provided with a screw thread, while the rear end comprises a screw head. The annular hammer can slide freely on the tie rod, which is connected to the clamping head by means of a connecting sleeve, which is screwed onto the clamping head.

When using this extraction device for extracting a rolling bearing from a blind hole, first, the clamping head is pushed through the rolling bearing. Afterwards, the transmission rod is subjected, by rotating it in the clamping head, to an axial action against the steel ball, which thereby causes an expansion of the clamping head in the rolling bearing. Afterwards, the connecting sleeve is screwed onto the clamping head, whereupon strokes of the annular hammer against the screw head of the screwing spindle may enable release of the rolling bearing in the blind hole, so that extraction of the rolling bearing can, thus, be achieved.

The document CN 202 010 995 U describes an extraction device for extracting a lining from an opening of a fuel injector. This extraction device comprises a thread element with a tapered part that is provided with a conical element on a free end and with a sleeve into which the tapered part can be screwed. The thread element is arranged in an outer sleeve, the free end of which accommodates the conical element at least partially. This free end is elastically deformable and increases or decreases in size in radial direction, when the conical element is moved therein, so as to enable able during use of the extraction device to clamp the free end of the outer sleeve in a corresponding lining of a fuel injector for extracting the lining.

The document CN 200 984 726 U describes a similar extraction device which, however, is not intended for extracting a lining from an opening of a fuel injector, but for extracting a rolling bearing from a blind hole. This extraction device exhibits a similar structure, but instead of an elastically deformable outer sleeve at its free end, it has a plurality of spreadable spreading arms, which can be spread by subjecting them to the action of a conical element.

Other devices, wherein spreading arms can be spread by applying a load thereto, are also known. For example, the document WO 2009/147527 A2 describes such a device.

However, the handling of all devices described above is comparatively complicated resulting in their use being time-consuming. Moreover, these devices cannot be used for extracting trim weights from rotor blades, since due to the rigid structure of the respective individual components, in particular of the transmission rod and the screwing spindle resp. the thread element and the outer sleeve as such, a respective access to the relatively difficult to access trim weights through the access openings provided in the rotor blades is not possible.

The document U.S. Pat. No. 1,593,437 describes an extraction device for extracting a friction bearing, in particular a bearing bush, from an opening. This extraction device includes an axially displaceable treaded rod, into which a tension screw provided with a retaining head can be screwed. For this purpose, however, the threaded rod and the tension screw must first be arranged on opposing axial ends of the bearing bush, so that the extraction device can only be used for continuous openings resp. through holes.

Accordingly, this extraction device cannot be used with blind holes. Moreover, this extraction device cannot be used for extracting trim weights from rotor blades, since due to the rigid structure of its individual components, in particular of the threaded rod and the tension screw, access to the relatively difficult to access trim weights through the access openings provided in the rotor blades is not possible.

### BRIEF SUMMARY OF THE INVENTION

Therefore, an object of the present invention consists in providing an extraction device for extracting a trim weight from a rotor blade, which enables an access to the relatively difficult to access trim weights through access openings provided in the rotor blades in an easy, safe, and reliable manner. Moreover, it is an object of the present invention to provide a method for using such an extraction device.

This object is solved by an extraction device for extracting a trim weight from a rotor blade having the features of claim 1.

According to the present invention, an extraction device for extracting a trim weight from a rotor blade comprises a supporting tube that is at least partly provided with a female thread, and a threaded rod that is at least partially arranged in the supporting tube. The threaded rod is coupled to a fixing element that is adapted for being detachably fixed to the trim weight and that is at least partially provided with a male thread which engages at least partially the female thread of the supporting tube. The threaded rod is at least partly plastically deformable.

Preferably, the threaded rod which is at least partly plastically deformable comprises a maximum diameter of 3 mm. Preferably, the supporting tube is rigid in its longitudinal direction, i.e. undeformable, but flexible in its radial resp. lateral direction, i.e. at least plastically deformable. Preferably, the threaded rod and the supporting tube are oriented coaxially to one another and movable in relation to one another, in particular by screwing the threaded rod in the supporting tube, i.e. by screwing it in or screwing it off the supporting tube. Preferably, an axial displacement of the supporting tube on the threaded rod is enabled by such a screwing operation.

According to one aspect, a spreading wedge can be displaced axially by means of an axial displacement of the supporting tube relative to the fixing element. In this respect, the fixing element can e.g. be designed in the manner of a bifurcated needle, which comprises at least two flexible, i.e. preferably elastically deformable, metallic needles. Preferably, these two needles build up spreading arms, which can be spread in an opening of the trim weight by axial displacement of the spreading wedge, in order to form a form-fit connection or a frictional locking connection with the trim weight.

Since the threaded rod is preferably at least partly plastically deformable, it can be deformed plastically prior to being used correspondingly for extracting the trim weight from the rotor blade, so as to enable an easy and uncomplicated access to the trim weight in the rotor blade. In particular, an alignment of the threaded rod resp. the spreading arms in relation to the opening of the trim weight can thereby be achieved.

Advantageously, the extraction device according to the invention enables comparatively high tensile loads of up to 200 N during extraction in case of openings in corresponding trim weights with a maximum diameter of 3.5 mm. Moreover, the threaded rod, which is at least partly plastically deformable, does not only enable an alignment of the spreading arms in relation to the respective opening of a trim weight, but also an access to trim weights which are very difficult to access. Accordingly, trim weights which cannot be extracted using conventional hand tools, can now be extracted easily. This advantageously reduces the period of time and the costs of corresponding maintenance works. Moreover, the extraction device according to the invention is comparatively cost-efficient and easy to handle so that no time-consuming trainings resp. briefings are required.

According to a preferred embodiment, the fixing element comprises at least two elastically deformable spreading arms that are adapted for being detachably fixed to the trim weight.

According to another preferred embodiment, the at least two elastically deformable spreading arms can be spread in an opening of the trim weight to enable a form-fit connection or a frictional connection between the at least two elastically deformable spreading arms and the trim weight.

According to another preferred embodiment, at least one spreading wedge is provided for expanding the at least two elastically deformable spreading arms.

According to another preferred embodiment, the at least one spreading wedge is movable in a translatory manner between the at least two elastically deformable spreading arms.

According to another preferred embodiment, the at least one spreading wedge is at least movable in a translatory manner in an associated spreading wedge advancing direction in-between the at least two elastically deformable spreading arms by means of an axial displacement of the supporting tube in an associated supporting tube advancing direction.

According to another preferred embodiment, the supporting tube is axially displaceable on the threaded rod by means of a screwing operation of at least one section of the supporting tube on the threaded rod.

According to another preferred embodiment, an actuating member is provided that is adapted for screwing together the at least one section of the supporting tube and the threaded rod upon actuation.

According to another preferred embodiment, the at least two elastically deformable spreading arms are pretensioned in relation to one another by at least one elastic pretensioning element.

According to another preferred embodiment, the at least one elastic pretensioning element is embodied in the form of a heat-shrinkable flexible tube.

According to another preferred embodiment, the at least one elastic pretensioning element is adapted for preventing slipping out of the at least one spreading wedge from an accommodation area provided between the at least two elastically deformable spreading arms.

According to another preferred embodiment, the at least two elastically deformable spreading arms are permanently mounted to the threaded rod.

According to another preferred embodiment, the supporting tube is at least partly plastically deformable.

According to another preferred embodiment, an annular hammer is arranged on the supporting tube in an axially displaceable manner.

Moreover, the present invention provides a method for extracting a trim weight from a rotor blade with an extraction device according to the invention. The method comprises at least the following steps: Plastically deforming at least the threaded rod for enabling access to the trim weight in the rotor blade; accessing the trim weight that is arranged in the rotor blade through an access opening provided in the rotor blade; detachably fixing the fixing element to the trim weight; and extracting the trim weight from the rotor blade by pulling the extraction device.

### BRIEF DESCRIPTION OF THE DRAWINGS

Further details and advantageous further developments of the invention result from the embodiments described below and shown in the drawings, which shall not be deemed as a limitation of the invention.

FIG. 1 shows a perspective view of a multi-blade rotor with a plurality of trim weight arrangements,

FIG. 2 shows a top view of a trim weight arrangement and an extraction device according to the invention during extraction of a trim weight,

FIG. 3 shows a close-up view III of FIG. 2,

FIG. 4 shows a perspective view of a fixing element according to the invention, of the extraction device of FIG. 2 and FIG. 3 with the trim weight of FIG. 2 and FIG. 3,

FIG. 5 shows a sectional view of the fixing element of FIG. 4,

FIG. 6 shows a partially perspective, sectional view of the extraction device of FIG. 2 and FIG. 3,

FIG. 7 shows a top view of a section of the extraction device of FIG. 2 with an annular hammer according to one embodiment,

FIG. 8 shows a side view of a section of the fixing element of FIG. 4 arranged in an opening of the trim weight of FIG. 4, and

FIG. 9 shows a side view of the section of the fixing element of FIG. 8 which reaches at least partially through the opening of the trim weight of FIG. 4.

### DETAILED DESCRIPTION OF THE INVENTION

In the following description, the terms left, right, front, rear, top, and bottom refer to the respective figure and may vary from one figure to another depending on the selected orientation (portrait or landscape format). Equal or equally acting parts are given the same reference in different figures and are usually described only once.

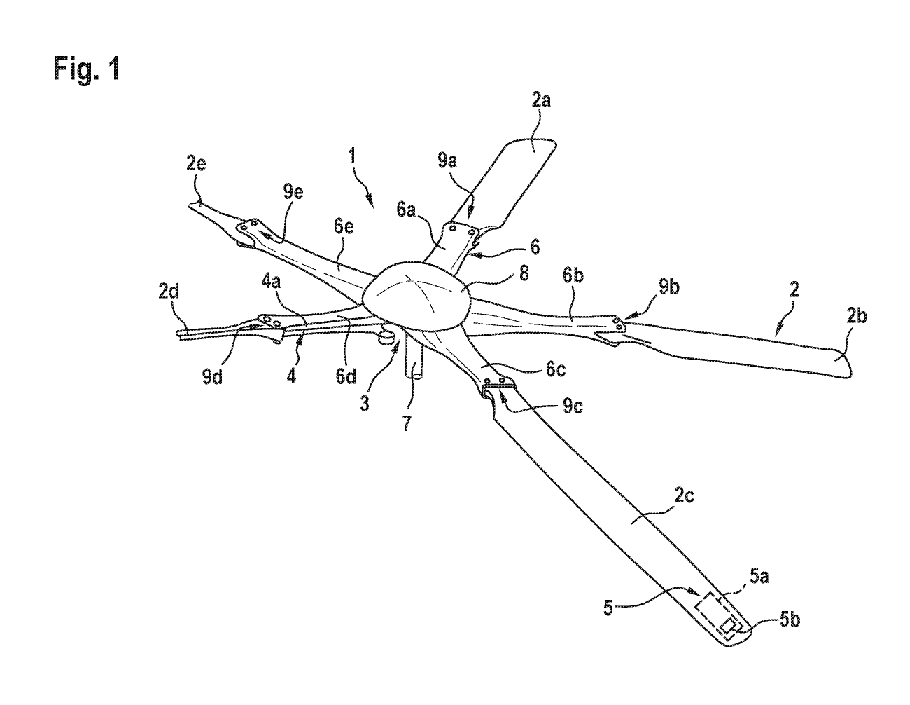

FIG. 1 shows a multi-blade rotor 1 of a rotary wing aircraft which can be used as main rotor of a helicopter according to one embodiment. By way of example, the multi-blade rotor 1 comprises a rotor head 3 which is arranged on a rotor mast 7 and illustratively covered by a rotor head cover 8. The rotor mast 7 forms a rotation axis of the multi-blade rotor 1 around which a plurality of rotor blades 2 rotate during operation.

By way of example, the multi-blade rotor 1 is embodied as a hinge- and bearingless rotor, wherein the plurality of rotor blades 2, which illustratively includes five rotor blades 2a, 2b, 2c, 2d, 2e, is preferably connected to the rotor head 3 by means of a plurality of flexbeam elements 4. The plurality of rotor blades 2 is fastened to the plurality of flexbeam elements 4 via corresponding rotor blade connections 9a, 9b, 9c, 9d, 9e.

The plurality of rotor blades 2 resp. the plurality of flexbeam elements 4 is preferably associated with a plurality of control cuffs 6 through which the rotor blades 2a, 2b, 2c, 2d, 2e are actuated during operation to adjust their angle of attack as required. Accordingly, the plurality of control cuffs 6 comprises five control cuffs 6a, 6b, 6c, 6d, 6e which are each associated with the rotor blades 2a, 2b, 2c, 2d, 2e.

The control cuffs 6a, 6b, 6c, 6d, 6e at least essentially encompass a respectively associated flexbeam element of the plurality of flexbeam elements 4 so that the latter are not visible in FIG. 1. For simplicity and clarity of the drawing, the control cuff 6d is only partly shown to illustrate representatively for the plurality of flexbeam elements 4 a flexbeam element 4a that is encompassed by this control cuff.

According to an embodiment, the plurality of rotor blades 2 comprises a plurality of trim weight arrangements 5 to trim the rotor blades 2a, 2b, 2c, 2d, 2e, wherein a corresponding trim weight arrangement is preferably associated with each one of the rotor blades 2a, 2b, 2c, 2d, 2e. For simplicity and clarity of the drawing, however, only one trim weight arrangement 5a is separately labelled representative for the plurality of trim weight arrangements 5, which is arranged inside the rotor blade 2c and accessible through an access opening 5b provided at the rotor blade 2c.

At this point, it should be noted that the structure and functioning of the multi-blade rotor 1 as such is sufficiently known to the person skilled in the art and not the subject matter of the present invention. This is why the structure and the function are not further described for conciseness and clarity of the description. However, it should also be noted that the multi-blade rotor 1 is depicted to illustrate an exemplary use and arrangement of the trim weight arrangement 5a resp. of the plurality of trim weight arrangements 5 in order to illustrate a preferred field of application of the extraction device described below. But in general, the latter can be used on any rotor that is provided with corresponding trim weight arrangements irrespective of a respective rotor design.

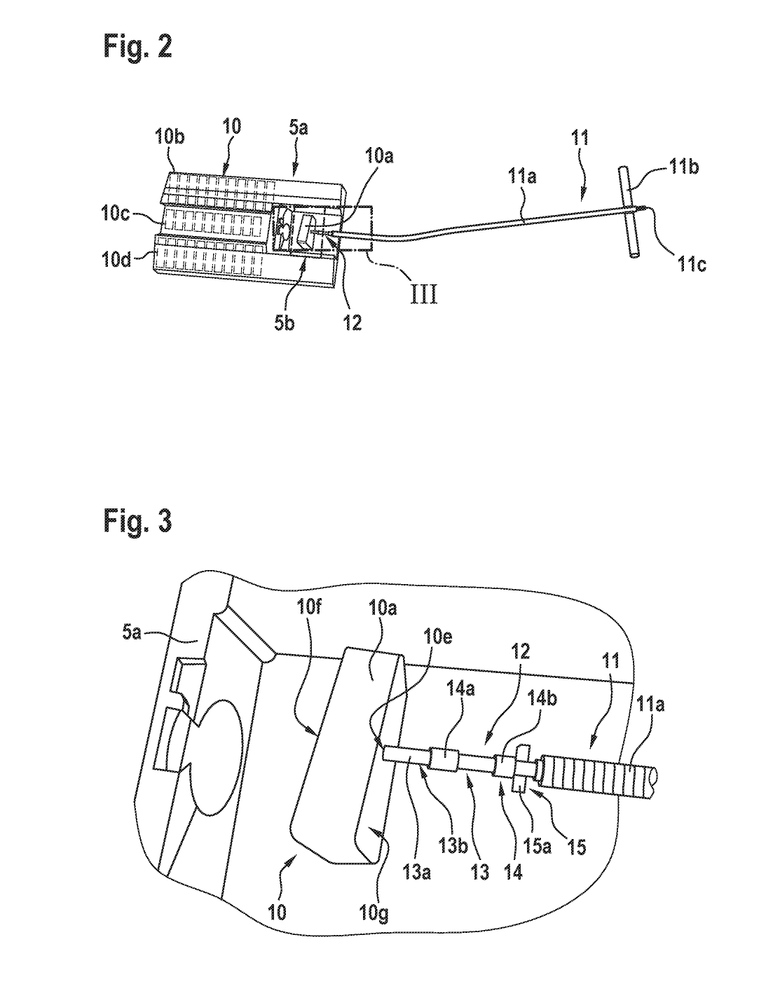

FIG. 2 shows the trim weight arrangement 5a of FIG. 1 which exemplarily includes a plurality of trim weights 10 whereof four trim weights 10a, 10b, 10c, 10d are illustratively labelled separately. The plurality of trim weights 10 can be arranged directly in the rotor blade 2c of FIG. 1 but, as an alternative, it can also be arranged in an associated trim weight box resp. an associated trim weight housing, which in turn is arranged in the rotor blade 2c of FIG. 1. However, only the trim weight arrangement 5a with the schematically represented access opening 5b of rotor blade 2c of FIG. 1 is shown for simplicity and clarity of the drawing.

Moreover, FIG. 2 shows an extraction device 11 according to one embodiment which is preferably at least adapted for extracting trim weights from rotor blades. Illustratively, the extraction device 11 is depicted during extracting the trim weight 10a from the rotor blade 2c of FIG. 1.

The extraction device 11 preferably comprises a supporting tube 11a and a threaded rod 11c that is at least partially arranged in the supporting tube 11a. The threaded rod 11c is preferably coupled to a fixing element 12 that is adapted for being detachably fixed to the trim weight 10a and is, preferably, at least partly plastically deformable. This plastical deformability advantageously enables an access of the extraction device 11 to the trim weight 10a through the comparatively small opening 5b in an easy way.

The supporting tube 11a is preferably rigid in its longitudinal direction, i.e. undeformable resp. at least not deformable manually without any auxiliary means. In its radial resp. lateral direction, however, the supporting tube 11a is preferably flexible, i.e. at least plastically deformable. Accordingly, when using the extraction device 11, the supporting tube 11a can be bent in any direction and in doing so be bent within large limits, but cannot be extended by pulling. This preferably applies by analogy to the threaded rod 11c.

FIG. 3 shows a section III of the arrangement of FIG. 2 to illustrate the fixing element 12 of the extraction device 11, which is detachably fixed to the trim weight 10a. In this respect, the fixing element 12 preferably reaches at least partly through an opening 10e provided in the trim weight 10a. This opening 10e can either be a blind hole or a through hole.

The trim weight 10a illustratively has a rear side 10f arranged on the left in FIG. 3 and an opposing front side 10g arranged on the right in FIG. 3. By way of example, the fixing element 12 of the extraction device 11 reaches from the front side 10g into the opening 10e of the trim weight 10a through the access opening 5b of FIG. 1 and FIG. 2.

The fixing element 12 preferably comprises a plurality of spreading arms 13. The plurality of spreading arms 13 preferably comprises at least two elastically deformable spreading arms 13a, 13b that are adapted for being detachably fixed to the trim weight 10a. Preferably, these spreading arms 13a, 13b can be spread in the opening 10e of the trim weight 10a to enable a form-fit connection or a frictional locking connection of the spreading arms 13a, 13b with the trim weight 10a.

The formation of a corresponding frictional locking connection is described below at FIG. 8. The formation of a corresponding form-fit connection is described below at FIG. 9.

In order to spread the spreading arms 13a, 13b, preferably at least one spreading wedge 15 is provided which is preferably at least partly cone-shaped on one axial end. Preferably, the latter is movable in a translatory manner between the spreading arms 13a, 13b and is, according to one aspect, provided with a guide carriage 15a for advance. The guide carriage 15a is preferably provided on an axial end of the spreading wedge 15 that opposes the cone-shaped end, so that the spreading wedge 15 with the guide carriage is at least roughly T-shaped.

Preferably, the spreading arms 13a, 13b are pretensioned relative to one another by at least one elastic pretensioning element. Preferably, the spreading arms 13a, 13b are pretensioned relative to one another by a plurality of elastic pretensioning elements 14 and, illustratively, the spreading arms 13a, 13b are pretensioned relative to one another by two elastic pretensioning elements 14a, 14b. Preferably, at least one and, illustratively, both elastic pretensioning elements 14a, 14b are embodied in the manner of shrinkable flexible tubes. As an alternative, the elastic pretensioning elements 14a, 14b can be embodied in the manner of any elastic ring element, in particular plastic rings.

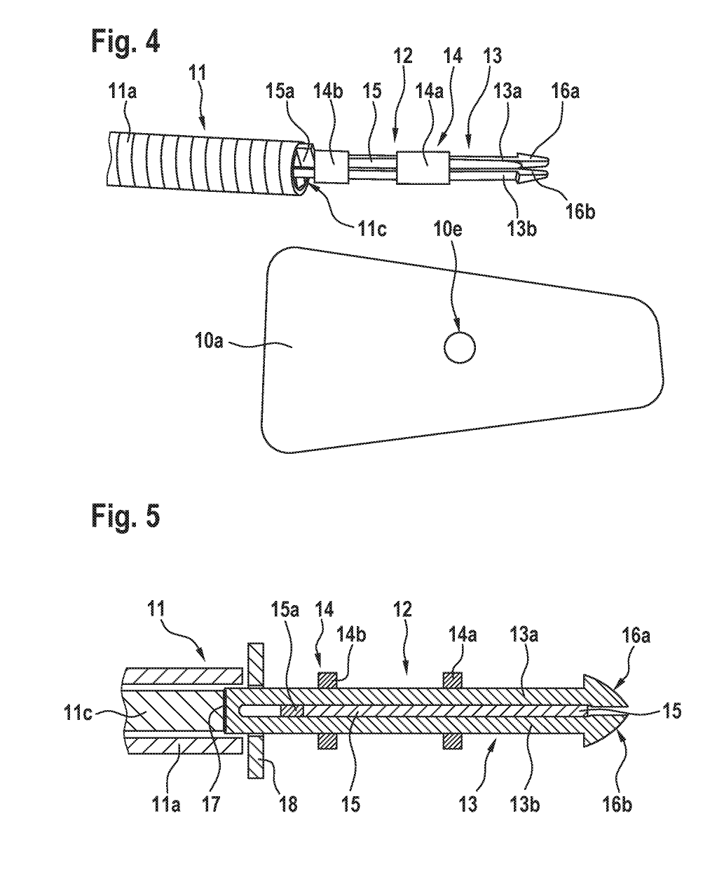

FIG. 4 shows the trim weight 10a of FIG. 3 to illustrate the opening 10e provided therein as well as the fixing element 12 with the spreading wedge 15 of FIG. 3 to illustrate the arrangement of the spreading wedge 15 in an accommodation area provided between the spreading arms 13a, 13b of the fixing element 12. In this respect, the elastic pretensioning elements 14a, 14b of FIG. 3 are preferably adapted so as to prevent the spreading wedge 15 from slipping out of the accommodation area provided between the spreading arms 13a, 13b.

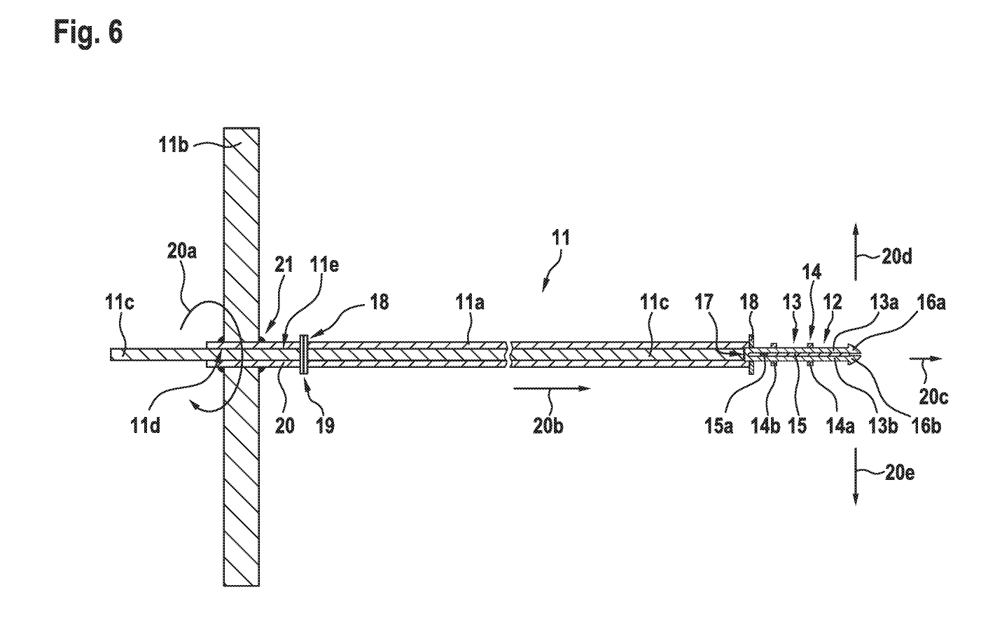

By way of example, the spreading wedge 15 is shown in a spread position in which it spreads the spreading arms 13a, 13b. In this spread position, the guide carriage 15a of the spreading wedge 15 is preferably subjected to the action of the supporting tube 11a of FIG. 2. A movement of the spreading wedge 15 into this spread position by means of a translatory motion is preferably effected by an axial displacement of the supporting tube 11a on the threaded rod 11c and a simultaneous loading of the guide carriage 15a as described at FIG. 6 below.

According to one aspect, the spreading arms 13a, 13b are permanently fastened to the threaded rod 11c. Such a permanent fastening can e.g. be achieved by a welded connection (17 in FIG. 5), but alternatively also by a screw or rivet connection. Moreover, such a permanent fastening can also be provided by an integral connection resp. molding of the spreading arms 13a, 13b with resp. at to the threaded rod 11c.

The spreading arms 13a, 13b preferably comprise associated head sections 16a, 16b at their free ends. These are preferably designed as wedges and are hereinafter referred to as “spreading arm heads”. Illustratively, the spreading arm 13a defines a top spreading arm which comprises the spreading arm head 16, and the spreading arm 13b defines a bottom spreading arm which comprises the spreading arm head 16b. In the respective areas of the spreading arm heads 16a, 16b, the spreading arms 13a, 13b are preferably embodied in the form of ramps, as depicted in FIG. 8 and FIG. 9 by way of example.

FIG. 5 shows the fixing element 12 of FIG. 2 to FIG. 4 with the spreading arms 13a, 13b to illustrate a permanent fastening of these spreading arms 13a, 13b to the threaded rod 11c. Moreover, FIG. 5 shows an end disk 18 arranged at the supporting tube 11a of FIG. 2 to FIG. 4, which preferably serves to transfer an advance force of the supporting tube 11a to the guide carriage 15a of the spreading wedge 15 of FIG. 3 and FIG. 4 to move the spreading wedge 15 into the spreading position as described at FIG. 4.

Preferably, the spreading arms 13a, 13b are fastened to the threaded rod 11c using a welded connection 17 as described at FIG. 4. According to one aspect, the spreading arms 13a, 13b are built up by means of a bifurcated needle which comprises at least two flexible, i.e. preferably elastically deformable metallic needles whereof one forms the top spreading arm 13a and the other one forms the bottom spreading arm 13b. In this case, the bifurcated needle is connected to the threaded rod 11c through the welded connection 17.

FIG. 6 shows the extraction device 11 of FIG. 2 to FIG. 5 with the supporting tube 11a, the actuating member 11b, the treaded rod 11c, and the fixing element 12. The supporting tube 11a is preferably at least partly provided with a female thread 11d and the threaded rod 11c that is at least partially arranged in the supporting tube 11a is preferably at least partly provided with a male thread 11e which engages at least partially the female thread 11d. The female thread 11d and the male thread 11e preferably exhibit a corresponding design and are in particular adapted to enable a screw connection of the supporting tube 11a on the threaded rod 11c resp. a screw connection of the threaded rod 11c in the supporting tube 11a.

According to one aspect, the supporting tube 11a is provided with a sleeve nut 20 which is connected via an associated joining element 19 to a right section of the supporting tube 11a in FIG. 6 that faces the fixing element 12. The connection may be a loose connection, i.e. the sleeve nut 20 and the right section of the supporting tube 11a can be implemented as separate components. Illustratively, the joining element 19 comprises two end disks 18 serving for transmission of forces.

The sleeve nut 20 is preferably fastened to the actuating member 11b by means of a suitable fixture 21, e.g. a welded connection. The actuating member 11b is preferably adapted for screwing together upon actuation at least the sleeve nut 20 and the threaded rod 11c, so that the female thread 11d may also be provided exclusively in the sleeve nut 20. In particular, preferably only the sleeve nut 20 is provided with the female thread 11d.

According to one aspect, the supporting tube 11a is displaceable in an axial resp. translatory manner on the threaded rod 11c by a screwing operation of the sleeve nut 20 on the threaded rod 11c. Illustratively, a screwing operation of the sleeve nut 20 into an exemplary rotating direction 20a can be achieved by a rotation of the actuating member 11b, e.g. clockwise. The sleeve nut 20 is thereby displaced in an axial resp. translatory manner on the threaded rod 11c in direction of an arrow 20b and, in doing so, pushes by means of the joining element 19 the right section of the supporting tube 11a, which preferably does not comprise a female thread, in an axial resp. translatory manner in direction of the arrow 20b, so that the latter indicates an advancing direction of the supporting tube 11a. In doing so, the guide carriage 15a of the spreading wedge 15 is subjected to the action of the supporting tube 11a through the end disk 18, so that the spreading wedge 15 is displaced in an axial resp. translatory manner in an advancing direction 20c that corresponds to the advancing direction of the supporting tube 11a. Accordingly, the spreading wedge 15 is at least movable in an axial resp. translatory manner in the spreading wedge advancing direction 20c between the spreading arms 13a, 13b by means of an axial resp. translatory displacement of the supporting tube 11a in the supporting tube advancing direction 20b. The spreading arms 13a, 13b are thereby spread as illustrated by arrows 20d, 20e.

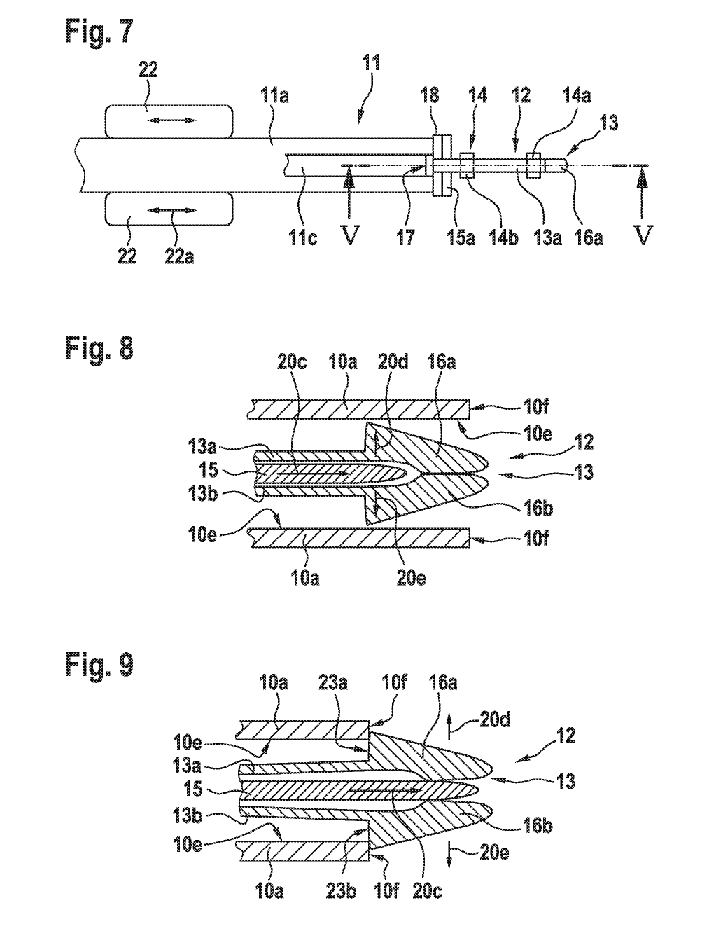

FIG. 7 shows a section of the extraction device 11 of FIG. 2 to FIG. 6, which is provided with an annular hammer 22 according to one aspect. This annular hammer 22 is preferably arranged on the supporting tube 11a and axially movable on the latter as shown by arrows 22a. By way of example, the annular hammer 22 can be used to apply sudden impulses on the joining element 19 resp. the actuating member 11b of FIG. 6 when extracting the trim weight 10a of FIG. 2 from the rotor blade 2c of FIG. 1, in order to enable loosening of the trim weight 10a.

Moreover, FIG. 7 shows the end disk 18 of FIG. 4 to FIG. 6 that is arranged between the supporting tube 11a and the guide carriage 15a of the spreading wedge 15 of FIG. 4 to FIG. 6. As described above, it serves for transmission of forces from the supporting tube 11a to the guide carriage 15a.

FIG. 8 shows the fixing element 12 of FIG. 2 to FIG. 6 with the spreading arms 13a, 13b and the spreading wedge 15, wherein the fixing element 12 is illustratively arranged in the opening 10e of the trim weight 10a of FIG. 4 in a way that the spreading arm heads 16a, 16b of the spreading arms 13a, 13b are at least essentially arranged inside the opening 10e. In this respect, by way of example the opening 10e is embodied as through hole between the front side 10g and the rear side 10f of the trim weight 10a.

According to one aspect, the spreading arm heads 16a, 16b can be spread in the opening 10e into the associated spreading arms spreading directions 20d, 20e of FIG. 6 by the translatory motion of the spreading wedge 15 in the spreading wedge advancing direction 20c of FIG. 6. A frictional locking connection can thereby be provided between the spreading arm heads 16a, 16b and the trim weight 10a.

Preferably, the frictional locking connection fixes the fixing element 12 at the trim weight 10a in such a way that the trim weight 10a can be pulled by means of the extraction device 11 of FIG. 2 to FIG. 6 into a direction that opposes the spreading wedge advancing direction 20c. In this way, the trim weight 10a can be extracted from the rotor blade 2c of FIG. 1.

FIG. 9 shows the fixing element 12 of FIG. 2 to FIG. 6 with the spreading arms 13a, 13b and the spreading wedge 15, wherein the fixing element 12 is illustratively arranged in the opening 10e of the trim weight 10a of FIG. 8 in a way that the spreading arm heads 16a, 16b of the spreading arms 13a, 13b are located outside of the opening 10e at the rear side 10f of the trim weight 10a. In doing so, the spreading arm heads 16a, 16b are spread in the associated spreading arms spreading directions 20d, 20e of FIG. 6 by the translatory motion of the spreading wedge 15 in the spreading wedge advancing direction 20c of FIG. 6. A form-fit connection can thereby be created between clamping surfaces 23a, 23b provided at the spreading arm heads 16a, 16b and the trim weight 10a.

Preferably, the form-fit connection fixes the fixing element 12 to the trim weight 10a in such a way that the trim weight 10a can be pulled by means of the extraction device 11 of FIG. 2 to FIG. 6 into a direction that is opposed to the spreading wedge advancing direction 20c. In this way, the trim weight 10a can be extracted from the rotor blade 2c of FIG. 1.

It should be noted that the embodiments of the extraction device according to the invention as described above as well as the description of possible uses are merely exemplary and not for limiting the invention accordingly. Numerous adaptations and modifications are instead possible and based on the knowledge of the person skilled in the art. Moreover, the extraction device according to the invention is not limited to extracting trim weights from rotor blades, but it can be used for various vehicles and machines with components which are quite difficult to access and to remove, or which cannot be extracted using conventional hand tools.

### REFERENCE SIGN LIST

1 Multi-blade rotor
2 Plurality of rotor blades
2a, 2b, 2c, 2d, 2e Rotor blades
3 Rotor head
4 Plurality of flexbeam elements
4a Flexbeam element
5 Plurality of trim weight arrangements
5a Trim weight arrangement
5b Access opening
6 Plurality of control cuffs
6a, 6b, 6c, 6d, 6e Control cuffs
7 Rotor mast
8 Rotor head cover
9a, 9b, 9c, 9d, 9e Rotor blade connections
10 Plurality of trim weights
10a, 10b, 10c, 10d Trim weights
10e Trim weight opening
10f Rear side of trim weight
10g Front side of trim weight
11 Extraction device
11a Supporting tube
11b Actuating member
11c Threaded rod
11d Female thread
11e Male thread
12 Fixing element
13 Plurality of spreading arms
13a Top spreading arm
13b Bottom spreading arm
14 Plurality of elastic pretenionsing elements
14a, 14b Elastic pretensioning elements
15 Spreading wedge
15a Guide carriage of spreading wedge
16a, 16b Spreading arm heads
17 Welded connection
18 End disks
19 Joining element
20 Sleeve nut
20a Rotating direction of sleeve nut
20b Supporting tube advancing direction
20c Spreading wedge advancing direction
20d, 20e Spreading arms spreading directions
21 Fixture of actuating member
22 Annular hammer
22a Annular hammer motion direction
23a, 23b Clamping surfaces

What is claimed is:

1. An extraction device for extracting a trim weight from a rotor blade, comprising a supporting tube that is at least partly provided with a female thread, and a threaded rod that is at least partially arranged in the supporting tube, wherein the threaded rod is coupled to a fixing element that is adapted for being detachably fixed to the trim weight and that is at least partially provided with a male thread which engages at least partially the female thread of the supporting tube, and wherein the threaded rod is at least partly plastically deformable.

2. The extraction device of claim 1, wherein the fixing element comprises at least two elastically deformable spreading arms that are adapted for being detachably fixed to the trim weight.

3. The extraction device of claim 2, wherein the at least two elastically deformable spreading arms can be spread in an opening of the trim weight to enable a form-fit connection or a frictional locking connection between the at least two elastically deformable spreading arms and the trim weight.

4. The extraction device of claim 2, wherein at least one spreading wedge is provided for expanding the at least two elastically deformable spreading arms.

5. The extraction device of claim 4, wherein the at least one spreading wedge is movable in a translatory manner between the at least two elastically deformable spreading arms.

6. The extraction device of claim 5, wherein the at least one spreading wedge is at least movable in a translatory manner in an associated spreading wedge advancing direction in-between the at least two elastically deformable spreading arms by means of an axial displacement of the supporting tube in an associated supporting tube advancing direction.

7. The extraction device of claim 6, wherein the supporting tube is axially displaceable on the threaded rod by means of a screwing operation of at least one section of the supporting tube on the threaded rod.

8. The extraction device of claim 7, wherein an actuating member is provided that is adapted for screwing together the at least one section of the supporting tube and the threaded rod upon actuation.

9. The extraction device of claim 4, wherein the at least two elastically deformable spreading arms are pretensioned in relation to one another by at least one elastic pretensioning element.

10. The extraction device of claim 9, wherein the at least one elastic pretensioning element is embodied in the form of a heat-shrinkable flexible tube.

11. The extraction device of claim 9, wherein the at least one elastic pretensioning element is adapted for preventing slipping out of the at least one spreading wedge from a accommodation area provided between the at least two elastically deformable spreading arms.

12. The extraction device of claim 3, wherein the at least two elastically deformable spreading arms are permanently mounted to the threaded rod.

13. The extraction device of claim 1, wherein the supporting tube is at least partly plastically deformable.

14. The extraction device of claim 1, wherein an annular hammer is arranged on the supporting tube in an axially displaceable manner.

15. A method for extracting a trim weight from a rotor blade with an extraction device according to claim 1, comprising at least the following steps:
plastically deforming at least the threaded rod for enabling access to the trim weight in the rotor blade,
accessing the trim weight that is arranged in the rotor blade through an access opening provided in the rotor blade,
detachably fixing the fixing element to the trim weight, and
extracting the trim weight from the rotor blade by pulling the extraction device.
